(19) United States
(12) Patent Application Publication
(10) Pub. No.: US 2006/0082658 A1
(43) Pub. Date: Apr. 20, 2006

(54) Device for image stabilization of camera module

(75) Inventors: Yong-Gu Lee, Gyeonggi-do (KR); Young-Kwon Yoon, Gyeonggi-do (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/063,162

(22) Filed: Feb. 22, 2005

(30) Foreign Application Priority Data
Oct. 18, 2004 (KR) 2004-83001

(51) Int. Cl. H04N 5/228

(52) U.S. Cl. 348/208.7; 348/208.2; 348/374

(57) ABSTRACT

A device for image stabilization of a camera module is disclosed. The device includes a housing; a moving unit for image stabilization, which is disposed in the housing so as to mount the image sensor and causes the image sensor to move horizontally/vertically for the purpose of image stabilization, a guide means disposed in the housing in order to guide the vertical/horizontal movement of the image sensor; and at least one connection means attached to the image sensor. The connection means is freely and multi-directionally deformable according to the movement of the image sensor, while maintaining electric connection with the printed circuit board.

### CLAIM OF PRIORITY

This application claims priority to an application entitled “Device for Image Stabilization of Camera Module,” filed in the Korean Intellectual Property Office on Oct. 18, 2004 and assigned Serial No. 2004-83001, the contents of which are hereby incorporated by reference.

### BACKGROUND OF THE INVENTION

1. Field of the Invention

The present invention relates to a device for image stabilization of a camera module. More particularly, the present invention relates to a device for image stabilization of a camera module that has a simpler structure as compared to conventional devices.

2. Description of the Related Art

Generally, camera modules are mounted in video cameras, electronic still cameras, PC camera terminals, PDAs, etc., for the purpose of recognizing images.

Camera modules and imaging screens thereof are being downsized with development of high-density technology. For example, camera modules have been reduced in size so that users can carry them in their hands to take photographs without using stands or tripods have appeared.

More particularly, portable terminals are known that are equipped with such camera modules so that users can perform image communication with their partners and can take photographs of a desired object or video image.

For example, portable communication terminals can now be provided as high-performance composite terminals equipped with camera modules capable of catching, storing and sending images. This is in contrast to older portable communication terminals that function only as media for simple voice and short message communication.

However, one disadvantage of camera phones and video cameras is that it is difficult to take a stable photograph because users hold them in their hands to take photographs.

To solve this problem, there was an attempt to provide an image sensor for a conventional video camera, so that the image sensor can compensate for image unstabilization caused by unsteady hands. However, conventional camera phones or optical cameras are to compact to be equipped with such image stabilization sensors. Therefore, it remains a serious problem because the camera lens tends to be out of focus due to unstabilization resulting from trembling of hands during photographing.

As shown in FIG. 1, a camera module 1 is mounted on a printed circuit board 2. On the printed circuit board 2, attached are a flexible printed circuit board (FPCB) 3, electrically connected to the exterior, and a lens holder 5 in which an IR filter 4 is embedded. The lens holder 5 receives a lens assembly 6.

As shown in FIG. 2, a conventional image stabilization device 10 includes a support 11 and a guideline 12. Additionally, an image sensor 13 of the camera module is provided with a connection pin 13a for the purpose of making electrical contact with the printed circuit board 1 by soldering.

However, the above-mentioned conventional image stabilization device is electrically connected to the printed circuit board by means of the connection pin of the image sensor. This means that assembling such a camera module requires circumspection so that the inside of the camera module may not be affected by external forces.

There are numerous other shortcomings of the above-mentioned conventional arrangement. Since, the image sensor moves along with the camera module, it may be readily damaged and dislocated. However, when a flexible circuit is used instead of a conventional connection pin in order to solve the above problem, the flexible circuit must be long enough to be exposed to the exterior for the purpose of making electric connection. This causes an additional problem in that the flexible circuit may be readily damaged and the assembling work of the camera module is more complicated.

Further, when such a conventional image stabilization device is mounted on a desired product such as a camera phone and a compact camera device, there must be sufficient space to mount the connection. This, however, limits how much the product can be downsized and/or thinned.

### SUMMARY OF THE INVENTION

One aspect of the present invention relates to a device for image stabilization of a camera module that has a simpler structure as compared to conventional devices.

It is another aspect of the present invention relates to a device for image stabilization of a camera module, which includes a connection member easily deformable by trembling in a camera module, so that the connection means can be prevented from being damaged and electric connection with the camera module can be improved.

One embodiment of the present invention is directed to a device for image stabilization of a camera module including an image sensor, an IR filter and a printed circuit board, wherein the device for image stabilization. The device includes a housing, a moving unit for image stabilization, which is disposed in the housing so as to mount the image sensor and causes the image sensor to move horizontally/vertically for the purpose of image stabilization, a guide means disposed in the housing in order to guide the vertical/horizontal movement of the image sensor, and at least one connection means attached to the image sensor. The connection means is freely and multi-directionally deformable according to the movement of the image sensor, while maintaining electric connection with the printed circuit board.

### BRIEF DESCRIPTION OF THE DRAWINGS

The above and other aspects, features and embodiments of the present invention will be more apparent from the following detailed description taken in conjunction with the accompanying drawings, in which:

FIG. 1 is a lateral sectional view showing a conventional image sensor of a camera module;

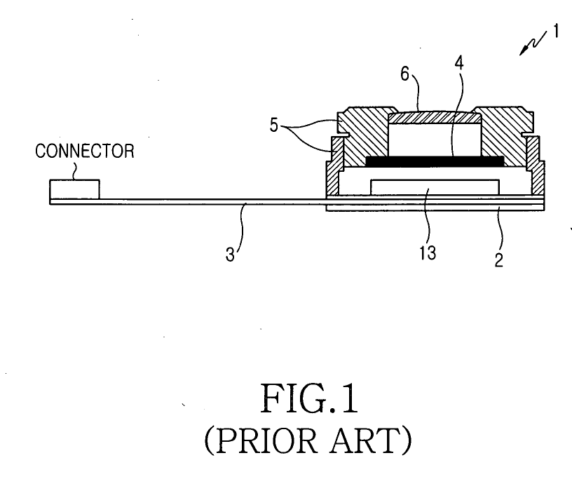

FIG. 2 is an exploded perspective view showing a conventional device for image stabilization of a camera module;

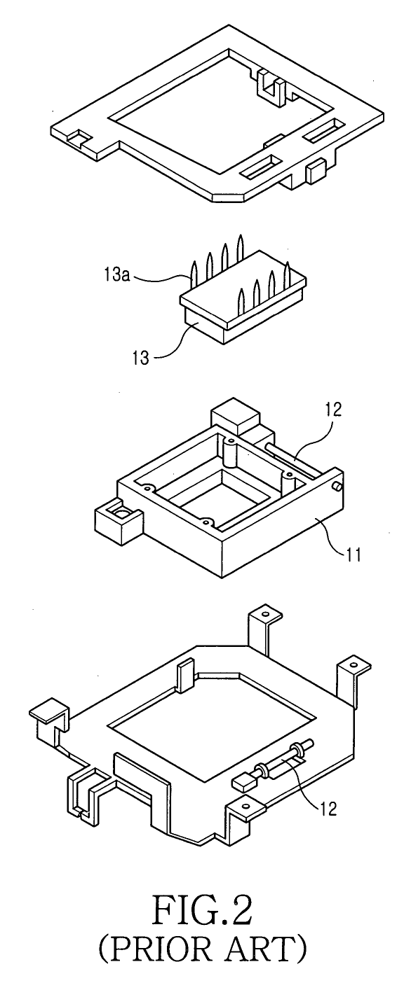

FIG. 3 is an exploded perspective view showing a device for image stabilization of a camera module according to an embodiment of the present invention;

FIG. 4 is a perspective view showing the linkage relationship in a device for image stabilization of a camera module according to an embodiment of the present invention;

FIG. 5 is a sectional view taken along line A-A′ in FIG. 4;

FIG. 6 is a sectional view taken along line A-A′ in FIG. 4, after the device for image stabilization of a camera module moves vertically;

FIG. 7 is a plan view showing a connection means in a device for image stabilization of a camera module according to an embodiment of the present invention;

FIG. 8 is a plan view showing a connection means in a device for image stabilization of a camera module according to an embodiment of the present invention, after moving horizontally;

FIG. 9 is a plan view showing a connection means in a device for image stabilization of a camera module according to an embodiment of the present invention, after moving vertically;

FIG. 10 is a plan view showing a connection means in a device for image stabilization of a camera module according to an embodiment of the present invention, after moving vertically/horizontally;

FIG. 11 is a lateral sectional view showing a connection means in a device for image stabilization of a camera module according to an embodiment of the present invention, after moving horizontally;

FIG. 12 is a plan view showing a connection means in a device for image stabilization of a camera module according to yet another embodiment of the present invention; and

FIG. 13 is a plan view showing a connection means in a device for image stabilization of a camera module according to yet another embodiment of the present invention, after moving horizontally.

### DETAILED DESCRIPTION

Hereinafter, embodiments of the present invention will be described with reference to the accompanying drawings. In the following description, the same elements will be designated by the same reference numerals although they are shown in different drawings. For the purposes of clarity and simplicity, a detailed description of known functions and configurations incorporated herein will be omitted when it may obscure the subject matter of the present invention.

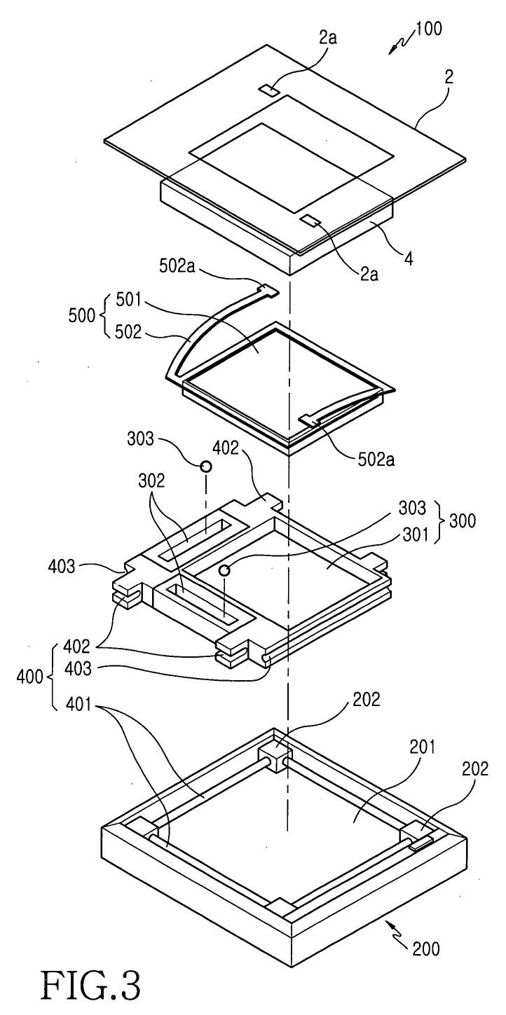

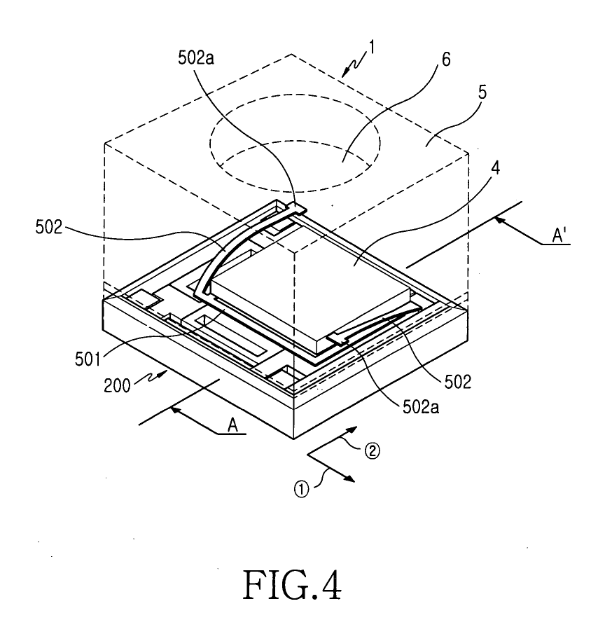

As shown in FIGS. 3 and 4, a device 100 for image stabilization of a camera module includes a housing 200, a moving unit 300 for image stabilization, a guide means 400 and at least one connection means 500. The housing 200 has an opening 201 at the top thereof. Through the opening 201, the guide means 400, the moving unit 300, the connection means 500 and an IR filter 4 are mounted. On the top surface of the housing 200, a printed circuit board 2 is disposed to which an image sensor 13 can be electrically connected. The moving unit 300 serves to mount the image sensor 13 and to move the image sensor 13 horizontally/vertically \textcircled{1}/\textcircled{2} for the purpose of image stabilization. The guide means 400 guides the horizontal/vertical \textcircled{1}/\textcircled{2} movement of the image sensor 13. The connection means 500 can be deformed freely and multi-directionally according to the movement of the image sensor 13, while maintaining electric connection with the printed circuit board 2.

Additionally, as shown in FIG. 4, the housing 200 may take the form of a square.

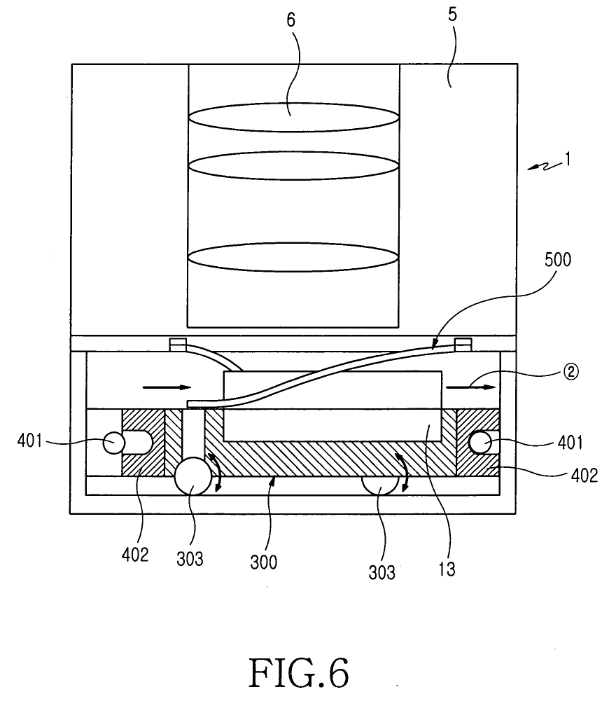

Further, as shown in FIGS. 4 and 6, the moving unit 300 has an inner space 301 opened for housing the image sensor 13 so that it can move along with the image sensor 13. The inner space 301 has at least one ball hole 302 at the outer circumference thereof. The ball hall 301 is capable of receiving balls 303 longitudinally in the direction of a lateral side of the moving unit 300 for image stabilization. One or more balls 303 are provided in in the ball hole 302 and are in close contact with the ball hole 302. Additionally, the balls 303 can move rotationally according to the movement of the moving unit 300 for image stabilization, while being engaged with and retained by the ball hole 302, along the longitudinal direction thereof.

Further, as shown in FIGS. 3, 5 and 6, the guide means 400 includes at least one guide bar 401, a pair of guide members 402 and at least one guide groove 403. The guide bars 401 are disposed along the inner circumference of the housing 200 so that they can be coupled movably with the guide members 402 and guide grooves 403 as described hereinafter. The guide members 402 are formed to protrude out from the outer circumference of the moving unit 300 for image stabilization. The guide members 402 can be coupled movably with the guide bars 401 in order to guide the horizontal/vertical \textcircled{1}/\textcircled{2} movement of the moving unit 300. The guide grooves 403 are formed on the outer circumference of the moving unit 300 for image stabilization. The guide grooves 403 can be coupled movably with the guide bars 401 in order to guide the horizontal/vertical movement of the moving unit 300. The guide members 402 are provided along the length of the lateral side of the moving unit 300, in parallel with each other on an equal line. Each guide groove 403 is formed longitudinally on the lateral side of the moving unit 300.

As shown in FIG. 3, the guide bars 401 are fixed by at least one fixing member 202 disposed at each corner inside of the housing 200.

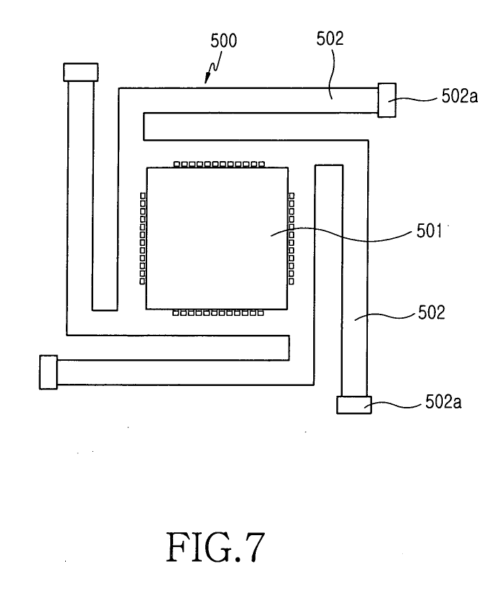

Meanwhile, as shown in FIGS. 7 to 11, the connection means 500 includes a main body 501 and at least one connection member 502. The main body 501 is attached on the top of the image sensor 13 by means of an epoxy adhesive. The connection members 502 are disposed along the outer circumference of the main body 501 at equiangular intervals. Each connection member 502 is connected and fixed to the main body 501 at one end thereof. Additionally, the other end of each connection member 502 can be freely and multi-directionally deformed according to the movement of the image sensor 13, while maintaining electric connection with the printed circuit board 2.

The connection members may be made of soft and/or flexible materials.

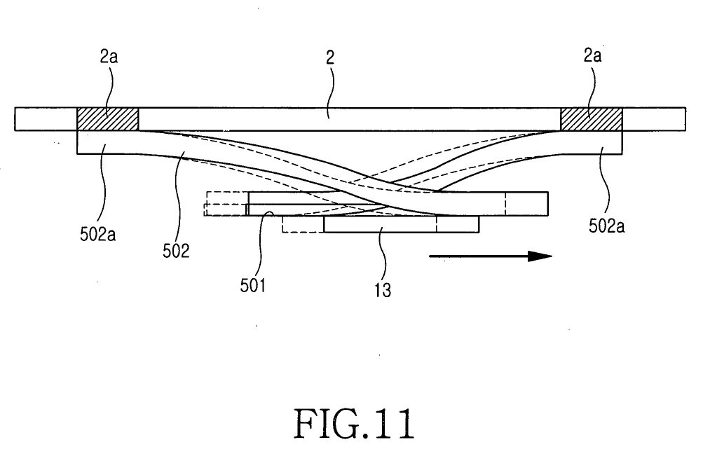

As shown in FIG. 11, each connection member 502 has a connector 502a at one end thereof. The connector 502a is electrically connected with another connector 2a mounted on the printed circuit board 2. The connection members 502 are disposed in so that they protrude out from an equal line symmetrically as well as crossing each other. Each connection member 502 is curvilinear so that it can be deformed easily and freely. Further, four connection members 52 are disposed around the main body 501 of the moving unit 300 for image stabilization.

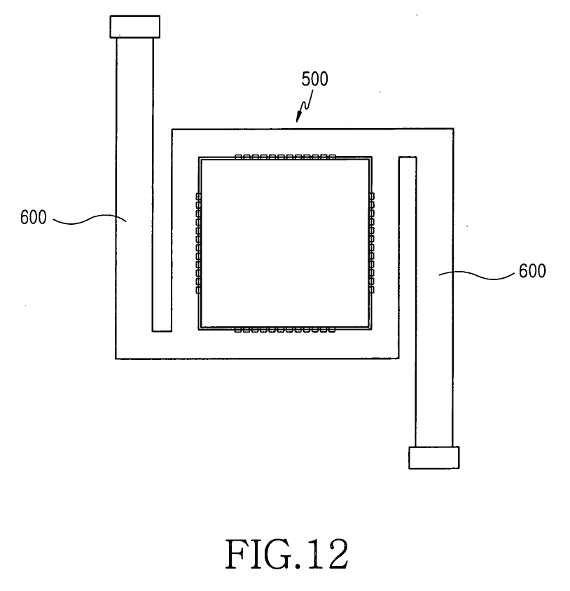

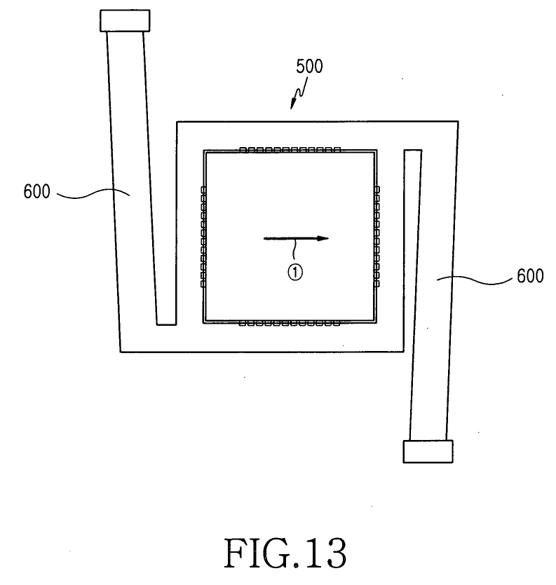

In another embodiment as shown in FIGS. 12 and 13, two connection members 502 are disposed around the main body 501 of the moving unit 300 for image stabilization.

Hereinafter, operation of the above-described device for image stabilization of a camera module will be explained in detail with reference to FIGS. 3 to 11.

As can been seen from FIGS. 3 and 4, the camera module 1 is provided with the housing 200 in which the guide means 400, the moving unit for image stabilization 300, the connection means 500 and the IR filter 4 are disposed.

In this state, when a user holds the camera and takes a photograph of a desired object, the moving unit 300 for image stabilization moves horizontally/vertically \textcircled{1}/\textcircled{2} if the user's hands tremble or move.

If this case, the image sensor 13 moves along with the moving unit 300.

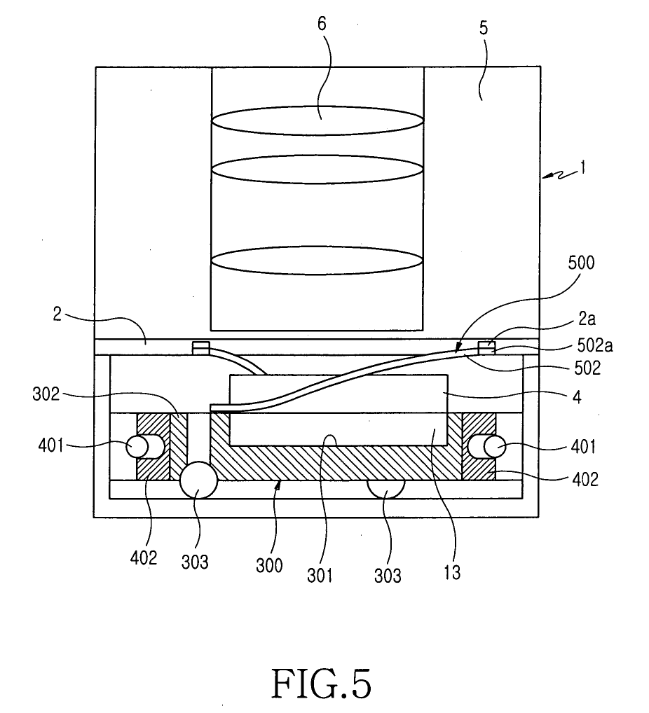

Additionally, as shown in FIGS. 5 and 6, the moving unit 300 has at least one ball hole 302 for receiving balls 303 longitudinally in the direction of a lateral surface. Under these circumstances, when the moving unit 300 moves horizontally/vertically \textcircled{1}/\textcircled{2}, it moves rotationally while being systematically engaged with the balls inside of the ball hole 302 on the bottom surface of the housing 200.

Further, the guide members 402 and guide grooves 403 are coupled movably with the guide bars 401 disposed around the inner circumference of the housing 200. Therefore, the guide members 402 and the guide grooves 403 are guided by the guide bars 401 according to the horizontal/vertical \textcircled{1}/\textcircled{2} movement of the moving unit.

Further, as shown in FIG. 7, the main body 501 of the connection means 500 is attached to the top surface of the image sensor 13. In addition, four connection members 502 are disposed along the outer circumference of the main body 501 for the purpose of making electric connection with the printed circuit board 2.

As depicted in FIGS. 5 and 6, one end of each connection member 502 is coupled to the main body 501 and the other end thereof is equipped with a connector 502a that can be electrically connected to another connector 2a formed on the printed circuit board 2.

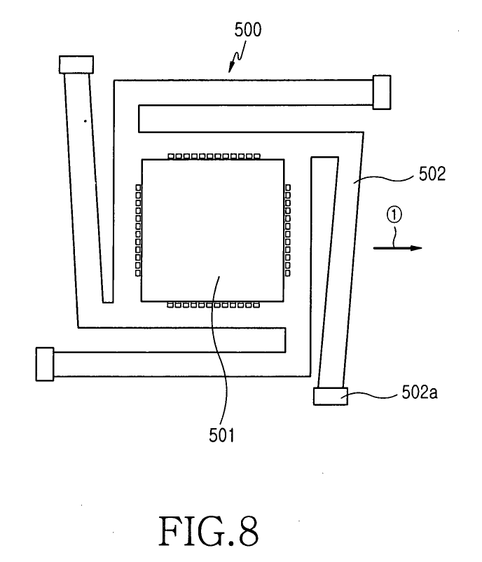

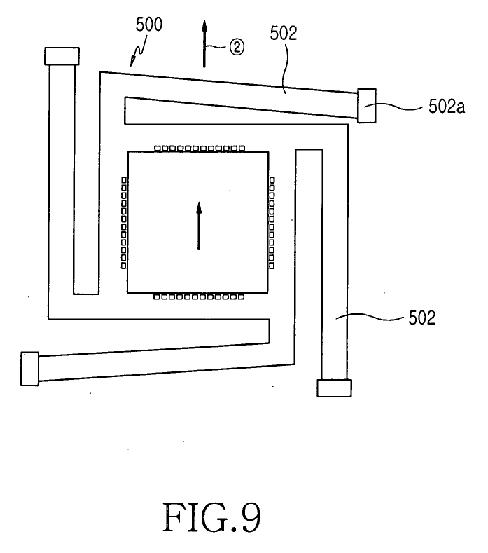

Under these circumstances, as shown in FIGS. 8 and 9, when the image sensor 13 moves horizontally/vertically \textcircled{1}/\textcircled{2} along with the moving unit 300, four connection members 502 are deformed freely and systematically along the direction of movement.

Particularly, as shown in FIG. 8, when the image sensor 13 moves horizontally \textcircled{1} along with the moving unit 300, one connection member 502 disposed at the left side of the main body 501 moves away from the main body by the moving distance, while another connection member 502 disposed at the right side of the main body moves toward the main body by the moving distance.

Still another connector members 502 disposed at the top and bottom of the main body 501 are bent in a curvilinear shape.

Meanwhile, as shown in FIG. 9, when the image sensor 13 moves vertically \textcircled{2} along with the moving unit 300, one connection member 502 disposed at the bottom of the main body 501 moves away from the main body by the moving distance, while another connection member 502 disposed at the top of the main body moves toward the main body by the moving distance.

Still another connector members 502 disposed at the left and right sides of the main body 501 are bent in a curvilinear shape.

Further, the above-described four connection members 502 are made of soft materials and thus can be deformed easily and freely.

More particularly, as shown in FIG. 11, the connection members 502 are curvilinear and are disposed so that they protrude out from an equal line symmetrically as well as crossing each other, thus can be deformed easily and freely in the horizontal/vertical direction \textcircled{1}/\textcircled{2}.

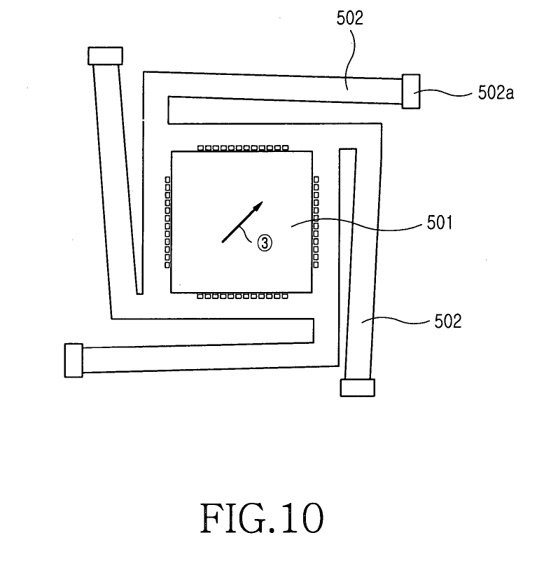

Further, as shown in FIG. 10, when the image sensor 13 moves diagonally \textcircled{3}, four connection members 502 systematically move away from and toward the main body 501 and are bent so that they can serve for multi-directional image stabilization of the camera module 1.

In another embodiment, connection means 500 of the device 100 for image stabilization of a camera module may have a structure as shown in FIGS. 12 and 13.

Two connection members 600 are disposed around the main body 501 of the connection means 500.

When the image sensor 13 moves horizontally \textcircled{1} along with the moving unit 300, one connection member 600 disposed at the left side of the main body 501 moves away from the main body by the moving distance, while another connection member 600 disposed at the right side of the main body moves toward the main body by the moving distance.

Further, when the image sensor 13 moves horizontally/vertically \textcircled{1}/\textcircled{2}, two connection members 600 systematically move away from and toward the main body 501 and are bent so that they can serve to stabilize the image of the image sensor 13.

When two connection members 600 having excellent adhesion to the image sensor 13 are used, it is possible to reduce power consumption.

As can be seen from the foregoing, the device for image stabilization according to embodiments of the present invention has a simple structure, and thus can be applied to a camera module having a compact and thinned shape. Additionally, connection members deformable easily and freely according to trembling of a camera module can be prevented from being damaged, and thus it is possible to improve electric connections in the camera module.

While the invention has been shown and described with reference to certain embodiments thereof, it will be understood by those skilled in the art that various changes in form and details may be made therein without departing from the spirit and scope of the invention as defined by the appended claims.

What is claimed is:

1. A device for image stabilization of a camera module including an image sensor, an IR filter and a printed circuit board, the device for image stabilization includes:
a housing;
a moving unit that is disposed in the housing so as to mount the image sensor and causes the image sensor to move horizontally/vertically;
a guide means disposed in the housing in order to guide the vertical/horizontal movement of the image sensor; and
at least one connection means attached to the image sensor, the connection means being freely and multi-directionally deformable according to the movement of the image sensor, while maintaining electric connection with the printed circuit board.

2. The device as claimed in claim 1, wherein the housing is disposed on a bottom of the printed circuit board and has a top opening and a closed bottom, and the guide means, the moving unit for image stabilization, the connection means and the IR filter are mounted through the top opening.

3. The device as claimed in claim 1, wherein the housing takes the form of a rectangle.

4. The device as claimed in claim 1, wherein the moving unit has an inner space opened for housing the image sensor, and the inner space has at least one ball hole at an outer circumference thereof, the ball hole being capable of receiving balls longitudinally in the direction of a lateral side of the moving unit, wherein the balls are provided so that they are received in the ball hole, are in close contact with the ball hole and can move rotationally according to the movement of the moving unit, while being engaged with and retained by the ball hole, along the longitudinal direction thereof.

5. The device as claimed in claim 1, wherein the guide means includes at least one guide bar, a pair of guide members and at least one guide groove, wherein the guide bar is disposed along an inner circumference of the housing, the guide members are formed to protrude out from an outer circumference of the moving unit so that they can be coupled movably with the guide bars in order to guide the horizontal/vertical movement of the moving unit, and the guide grooves are formed on the outer circumference of the moving unit so that they can be coupled movably with the guide bars in order to guide the horizontal/vertical movement of the moving unit.

6. The device as claimed in claim 5, wherein the guide members are provided along the length of the lateral side of the moving unit, in parallel with each other on an equal line.

7. The device as claimed in claim 5, wherein the guide grooves are provided along the length of the lateral side of the moving unit.

8. The device as claimed in claim 5, wherein the guide bars are fixed by at least one fixing member disposed at each corner inside of the housing.

9. The device as claimed in claim 1, wherein the connection means includes a main body attached to the image sensor and at least one connection member disposed along an outer circumference of the main body at equiangular intervals, wherein each connection member is connected and fixed to the main body at one end thereof, and remaining end of each connection member is capable of free and multi-directional deformation, while maintaining electric connection with the printed circuit board.

10. The device as claimed in claim 9, wherein the connection member is made of a flexible material.

11. The device as claimed in claim 9, wherein each connection member has a connector at one end thereof, the connector being electrically connected with another connector mounted on the printed circuit board.

12. The device as claimed in claim 9, wherein the connection members are disposed so that they protrude out from an equal line symmetrically as well as crossing each other.

13. The device as claimed in claim 9, wherein the connection members have a curvilinear shape.

14. The device as claimed in claim 9, wherein four connection members are disposed around the main body of the moving unit for image stabilization.

15. The device as claimed in claim 9, wherein two connection members are disposed around the main body of the moving unit for image stabilization.

16. The device as claimed in claim 1, wherein the image sensor is attached to the printed circuit board by means of an epoxy adhesive.

17. The device as claimed in claim 1, wherein the camera module is coupled to a phone.

18. The device as claimed in claim 1, wherein the camera module is coupled to an imaging device.

19. A device for image stabilization of an image sensor comprising:
a housing;
a moving unit, disposed in the housing, that causes the image sensor to move horizontally and/or vertically;
a guide means, disposed in the housing, that guides the vertical and/or horizontal movement of the image sensor; and
at least one connector that couples the image sensor to a printed circuit board.

20. The device as claimed in claim 19, wherein the connector is freely and multi-directionally deformable according to the movement of the image sensor, while maintaining electric connection with the printed circuit board.

21. The device as claimed in claim 19, wherein the moving unit has an inner space for the image sensor, the inner space has at least one hole at an outer circumference thereof, the hole being capable of receiving at least one circular object longitudinally in the direction of a lateral side of the moving unit, wherein the circular object can move rotationally according to the movement of the moving unit.

22. The device as claimed in claim 19, wherein the guide means includes at least one guide bar, a pair of guide members and at least one guide groove, wherein the guide bar is disposed along an inner circumference of the housing, the guide members are formed to protrude out from an outer circumference of the moving unit so that they can be coupled movably with the guide bars in order to guide the horizontal/vertical movement of the moving unit, and the guide grooves are formed on the outer circumference of the moving unit so that they can be coupled movably with the guide bars in order to guide the horizontal/vertical movement of the moving unit.

23. The device as claimed in claim 19, wherein the image sensor is coupled to a phone.

24. The device as claimed in claim 19, wherein the image sensor is coupled to an imaging device.
